(19) United States
(12) Patent Application Publication
(10) Pub. No.: US 2002/0113119 A1
(43) Pub. Date: Aug. 22, 2002

(54) Universal adaptor for connecting additional modules and peripherals to an electronic host device and methods of making and using same

(75) Inventors: David H. Bessel, Poway, CA (US); Robert L. Hardacker, Escondido, CA (US)

Correspondence Address: STEVEN L. NICHOLS, RADER, FISHMAN & GRAVER PLLC, 10653 S. RIVER FRONT PARKWAY, SUITE 150, SOUTH JORDAN, UT, 84095, US

(73) Assignee: Sony Corporation and Sony Electronics Inc.

(21) Appl. No.: 09/789,241

(22) Filed: Feb. 20, 2001

(51) Int. Cl. G06F 17/00; G06K 7/08

(52) U.S. Cl. 235/375; 235/449

(57) ABSTRACT

An adapter can be used to connect a standard connector on an electronic device, such as a Set-Top Box (“STB”), with a specific connector on an external module, peripheral, electronic device, bus, cable, wire or the like that is to be connected to the electronic device. For example, different adapters can provide means for connecting a standard connector on an STB with any of a Point-of-Deployment card or module, a smart card, a PCMCIA card or a Memory Stick®. Consequently, the STB (or other electronic device) need not be manufactured with connectors configured for connecting all possible peripheral devices. Additionally, the STB (or other electronic device) need not be manufactured in different models with various combinations of connectors for the possible peripheral devices.

### FIELD OF THE INVENTION

The present invention relates to the field of electronic devices, particularly set-top boxes for use connecting television sets to cable and other proprietary networks. The present invention also relates to the efficient manufacture of such electronic devices. More specifically, the present invention relates to the field of installing and enhancing such electronic devices by connecting additional modules and/or peripherals to the device.

### BACKGROUND OF THE INVENTION

Cable and satellite television systems are extremely popular. These proprietary systems can provide subscribers with dozens, or even hundreds, of channels of television programming. In addition to television programming, these types of systems can also provide pay-per-view events, video-on-demand services and other data services, such as software transmission, Internet access, e-mail, and even telephony.

In order for the subscriber's television set and possibly other electronic equipment to interface with the cable or satellite system, the subscriber usually obtains a Set-Top Box (“STB”). The STB may be purchased by the subscriber or provided to the subscriber by the operator of the system. The STB is connected between the subscriber's television (or other electronic equipment) and the cable television system or satellite antenna. The STB then allows the subscriber to access the services provided by the system to which the subscriber has subscribed. For example, the STB can allow the subscriber to tune various channels available on the network, order pay-per-view or video-on-demand programming, and access other services available on the system.

Because each cable or satellite television system may be different in terms of services offered, supporting infrastructure, command protocols, etc., each STB must, to some extent, be adapted to operate with the system to which it is connected, so that it can effectively serve as an interface between that system and the subscriber's electronic equipment. Additionally, if a subscriber who owns an STB wishes to switch service providers or subscribe to additional services provided by the current service provider, the STB may need to be upgraded or reconfigured.

However, it is expensive and undesirable to open an STB to affect such an upgrade. In addition to the obvious cost of reprogramming and/or adding additional hardware to an STB, opening an STB for such upgrading exposes the internal components to dirt and possible physical damage. Moreover, if the STB is made easy to open or disassemble, the STB will be vulnerable to reverse engineering and to unscrupulous parties who wish to have or provide unauthorized access to the services of the cable network.

Therefore, to produce STBs that can be readily adapted to the needs of the subscriber and system where the STB is installed, while still protecting the internal components of the STB, manufacturers have taken to producing a more generic STB to which an additional module or peripheral (hereinafter collectively “module”) is connected to provide the particular hardware and/or software the STB will need to operate appropriately. This additional module may provide, for example, decoding for encoded premium channels to which a subscriber has subscribed, credit services for ordering services such as pay-per-view or video-on demand services, or other services and functions which the STB can be made to perform.

However, these additional modules and peripherals can also take many different forms. For example, the module may be a Point-of-Deployment (“POD”) card, a Personal Computer Memory Card International Association card (“PCMCIA card”), a smart card or a Sony® Memory Stick®. Each of these devices has developed somewhat independently and has a particular connection configuration for connecting to an STB. However, all these devices do share a common shape that is generally flat and rectangular, although sizes and proportions may vary among the modules.

Consequently, while an STB can be made somewhat generic and later modified to operate with a particular cable system by providing an additional module or modules, the STB manufacturer must provide ports, sockets, slots or connectors that can accept and interface with any or all of the different configurations, etc. associated with each of the various types of modules that a user might wish to connect to the STB. Providing a port or connector for all such possible add-on devices is difficult in terms of the sizing and expense of the device.

An alternative is to produce different lines of the same STB with various connections and combinations of connections for the various types of add-on modules. However, the expense of producing, inventorying, storing, etc. multiple product lines may be an undue drain on resources.

Consequently, there is a need in the art for a means of providing an STB that can accept and use any of the wide variety of additional modules that might be required to support that STB in a particular application.

Moreover, this problem is not restricted to STBs. A number of other electronic devices have a similar problem in which a variety of connections to an external module or peripheral, or other equipment, may be needed. Such electronic devices include, but are not limited to, interactive television sets, laptop and desktop computers, networked devices in a computer network (e.g., routers, servers, printers, etc.), etc.

### SUMMARY OF THE INVENTION

The present invention meets the above-described needs and others. Specifically, the present invention provides a means of providing an STB that can accept and use any of the wide variety of additional modules that might be required to support that STB in a particular application. Additionally, the present invention can be applied to make any electronic device more capable of accepting an electrical connection for a variety of modules, peripherals, buses, connectors and connections.

Additional advantages and novel features of the invention will be set forth in the description which follows or may be learned by those skilled in the art through reading these materials or practicing the invention. The advantages of the invention may be achieved through the means recited in the attached claims.

The present invention may be embodied and described as an adapter for providing a connection for carrying electrical signals between an electronic device and a second or peripheral electronic device. The adapter includes a rear connector for connection to the electronic device; and at least one forward connector for connection to the peripheral electronic device. The rear and the at least one forward connectors are electrically connected for carrying the electrical signals therebetween. The adapter may include a number of forward connectors each having different configurations for connecting to different peripheral electronic devices.

The adapter of the present invention is preferably one of a set of adapters, each adapter in the group having an identical standard rear connector, but differently configured forward connectors.

In addressing the problems described above in the field of set-top boxes, the electronic device with which the adapter of the present invention is used may be a set-top box, and the peripheral electronic device may be a Point-of-Deployment card or module, a PCMCIA card, a smart card or a Sony® Memory Stick®. Alternatively, the electronic device may be a computer, an interactive television set, or a networked device in a computer network.

The adapter may also include a guide rail for guiding the adapter into the electronic device. A latch may be used for holding the adapter in the electronic device until released with a tool specifically designed for releasing the latch. In such as case, an access is provided in a front portion of the adapter for allowing the tool for releasing the latch to access and release the latch.

The present invention also encompasses the methods of making and using the adapter described above. Specifically, the present invention encompasses a method of connecting a particular primary electronic device to any of a number of second or peripheral electronic devices, without providing connectors on the primary electronic device for each possible peripheral electronic device. This method is performed by selecting an adapter from a group of adapters, where each adapter in the group has a standard rear connector for connection to the electronic device and at least one different forward connector for connection to a specific peripheral electronic device, the adapter being selected in accordance with the specific peripheral electronic device to which the primary electronic device is being connected. The method concludes with connecting the selected adapter between the primary and peripheral electronic devices for carrying electronic signals between the primary and peripheral electronic devices.

The method of the present invention may also include inserting the adapter in a port of the primary electronic device. This may be performed by guiding the adapter into the port with a guide rail on the adapter. After insertion of the adapter, the method may include latching the adapter in the port. A latch for performing the latching holds the adapter in the port until released with a tool specifically designed for releasing the latch. In such a case, the method may include accessing the latch through an access in a front portion of the adapter.

The present invention also comprises a primary electronic device for using the adapter of the present invention. The primary electronic device is connected with one or more adapters to any of a plurality of peripheral electronic devices and includes a port for receiving any of a group of adapters, where each adapter in the group comprises a standard rear connector for connection to the electronic device and at least one different forward connector for connection to a specific peripheral electronic device. The port provides a connector for receiving the standard rear connector on an adapter from the group of adapters. The port may also include a stop for engaging a latch on one of the adapters.

The primary electronic device may be a set-top box, a computer, an interactive television set, a networked device in a computer network, or any other electronic device which can be enhanced by connection to a variety of other electronic devices.

### BRIEF DESCRIPTION OF THE DRAWINGS

The accompanying drawings illustrate preferred embodiments of the present invention and are a part of the specification. Together with the following description, the drawings demonstrate and explain the principles of the present invention.

FIG. 1 is a side view of an adapter for connecting an electronic device, such as an STB, to a bus, connector, peripheral or external module according to the present invention. Internal components are shown in ghost.

FIG. 2 is a front view of the adapter illustrated in FIG. 1.

FIG. 3 is a side view of a second embodiment of the adapter of the present invention. As in FIG. 1, internal components are shown in ghost.

FIG. 4 is a front view of the adapter illustrated in FIG. 3.

FIGS. 5 and 6 are front views of particular embodiments of the adapter illustrated in FIG. 1.

FIGS. 7, 8 and 9 are front views of particular embodiments of the adapter illustrated in FIG. 2.

FIG. 10 is an illustration of an adapter, as shown in FIG. 1 or 2, as inserted in an electronic host device according to the present invention.

### DETAILED DESCRIPTION OF THE PREFERRED EMBODIMENTS

As will be well known to those skilled in the electrical and computer arts, it is often necessary or desirable to form an electronic connection between two or more electronic devices. These connections allow for electronic communication between the connected devices thereby enhancing the functionality of the system.

These connections are typically made by placing a male connector of a first device in a receptacle of a second device. A male connector generally includes pins, plugs or electrical contacts that are received in a slot, port, socket or set of holes of a receptacle or female connector. However, it usually makes little, if any, difference which side of a connection provides the male connector and which provides the receptacle. Consequently, as used herein, the term “connector” shall be used to refer generally to any male connector that has, for example, pins, plugs, prongs, electrical contacts and the like, for connection with a receptacle. The term “connector” shall also refer to any and all equipment providing a means for receiving a male connector or the like, including slots, sockets, pin holes, plug or prong holes, electrical contacts, etc. A connector may be disposed directly on an electronic device or may be on a bus, cable, wire or other electrical line that runs between separate electronic devices.

As used herein, the term “electronic device” shall be used in its broadest sense to refer to any electronic device, particularly a device that can be connected to another electronic device. For example, the term “electronic device” shall include, but not be limited to, a Set-Top Box (“STB”), interactive television set, digital video disk player, computer (desktop, laptop or palmtop), printer (or other computer peripheral) and other networked devices.

In general principle, the present invention provides an adapter which can be used to connect a standard connector on an electronic device, such as a Set-Top Box (“STB”), with a specific connector on an external module, peripheral, electronic device, bus, cable, wire or the like. As will be described in detail below, the adapter of the present invention can be used with a wide variety of electronic devices for which it is necessary or desirable to provide an electronic connection to another device.

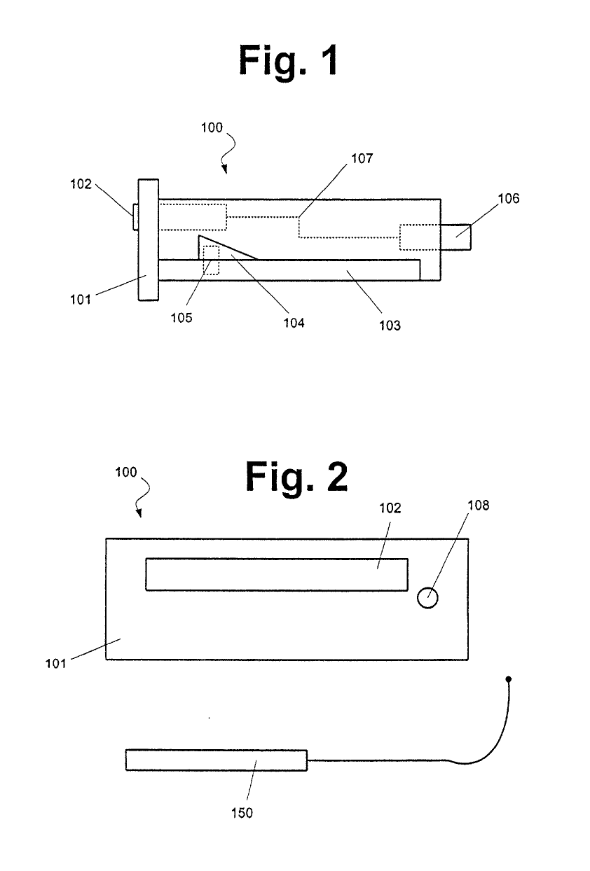

Using the drawings, the preferred embodiments of the present invention will now be explained. FIG. 1 illustrates a first embodiment of an adapter (100) according to the present invention. As shown in FIG. 1, the adapter (100) of the present invention includes a front panel (101) on which is provided at least one electrical connector (102). This connector (102) is typically, though not necessarily, a receptacle for receiving a connection from another electronic device, directly or by bus, cable or wire.

The connector (102) is electrically connected, preferably within the body of the adapter (100), with a second connector (106). The connector (106) is typically, though not necessarily, a male connector that is plugged into a standard receptacle of a host device. An electrical connection (107) carries electrical signals between the front connector (102) and the rear connector (106).

The adapter (100) also preferably includes a guide rail (103) for guiding the adapter into a host electronic device. A rail (103) may be provided on both sides of the adapter (100).

The adapter (100) also preferably includes a latch (104) that is biased in an extended position by a biasing device (105). The biasing device (105) may be, for example, a coil or leaf spring, or the like. As will be illustrated later, when the adapter (100) is inserted into and connected to an electronic device, the latch (104) may engage to hold the adapter (100) in the electronic device until the latch (104) is released. Preferably, a tool (150) designed specifically to release the latch (104) is required to release the latch (104) and remove the adapter (100) from the electronic device.

FIG. 2 illustrates a front view of the front panel (101) of the adapter (100) of the present invention. As shown in FIG. 2, the front panel (101) includes the forward connector (102) of the adapter. The front panel (101) also includes an access (108) into which the tool (150) can be inserted to release the latch (104). The access (108) may have a particular shape and/or angle that allows only a properly designed tool to reach and disengage the latch (104). Such configurations will be apparent from this description to those skilled in the art.

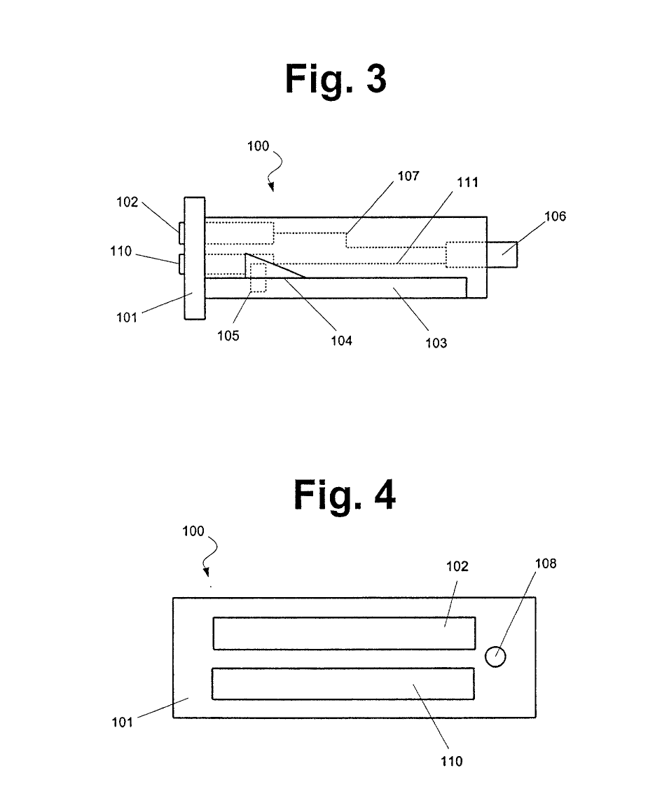

The adapter of the present invention is not limited to providing a single forward connector as illustrated in FIG. 1. Rather, the adapter (100) of the present invention can be made to include any number of forward connectors. As shown in FIG. 3, the adapter (100) has been modified to include a second forward connector (110) which is also connected to the standard rear connector (106) of the adapter (100). Again, an electrical connection (111), preferably within the body of the adapter (100), is provided between the second forward connector (110) and the rear connector (106).

FIG. 4 illustrates the front panel (101) of the adapter (100) shown in FIG. 3. As shown in FIG. 4, the front panel (101) of the adapter (100) of FIG. 3 includes both the first forward connector (102) and the second forward connector (110). The access (108) for disengaging the latch (104) is also provided.

In the context of an STB, a set of adapters (100), like those illustrated in FIGS. 1 to 4, can be used to make a connection between a generic STB and any of the possible external modules or peripherals. For example, the generic STB can be made with a single standard connector for receiving the rear connector (106) of an adapter (100) according to the present invention. The forward connector (102) of the adapter (100) is then made to conform to the configuration of a particular external module, for example, a Point-of-Deployment (“POD”) card, a Personal Computer Memory Card International Association card (“PCMCIA card”), a smart card or a Sony® Memory Stick®.

If the generic STB is to be connected to a POD card or module, an adapter (100) having the standard rear connector (106) and a forward connector (102) configured to connect to a POD card or module is connected to the generic STB. If, instead, the STB is to be connected to a smart card, a different adapter is used having the standard rear connector (106) and a forward connector (102) configured to connect to a smart card. In either case, the electrical connection(s) (107, 111) within the adapter (100) can be used to map the individual data lines of the forward connector (102) to data lines of the standard rear connector (106).

In this way, a generic STB can be manufactured with a standard connector for receiving the rear connector of the adapter (100). Different adapters can then be used, as needed, to connect any module, peripheral, card or other external device to the STB. Consequently, there is no need to manufacture an STB with connectors for all possible external connection configurations. There is also no need to manufacture different models of the STB with different connectors. These principles apply equally to other types of electronic devices and are not specific to STBs.

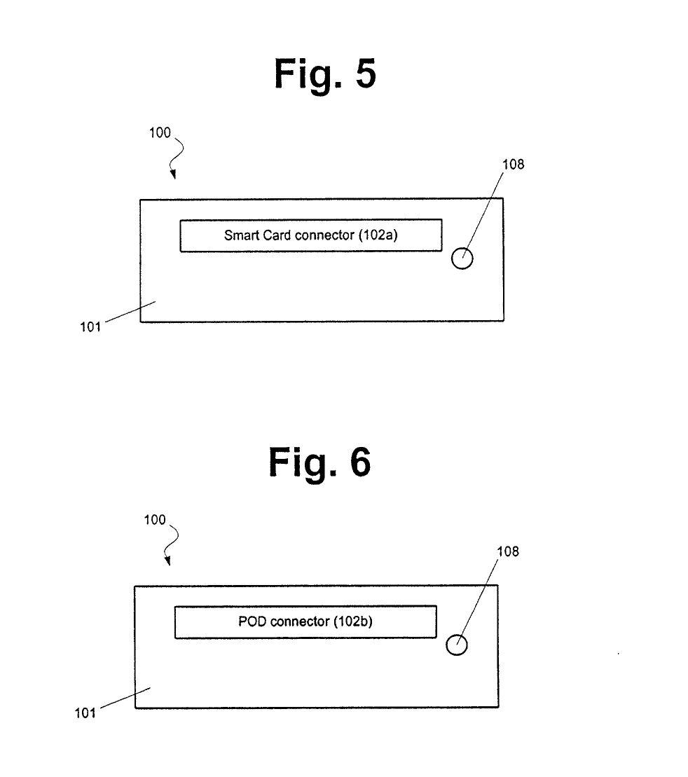

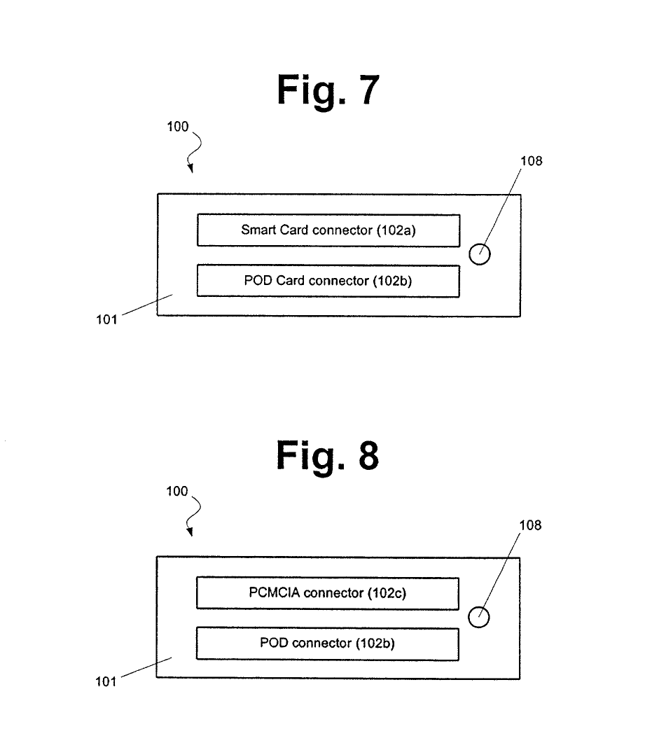

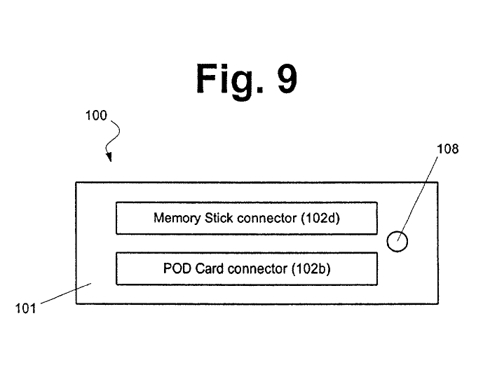

FIGS. 5 to 9 illustrate specific embodiments of the present invention for adapters to be used with STBs. FIG. 5 illustrates an adapter according to the present invention that provides a forward connector (102a) configured to connect with a smart card. FIG. 6 illustrates an adapter according to the present invention that provides a forward connector (102b) configured to connect with a POD card or module. FIG. 7 illustrates an adapter according to the present invention that provides two forward connectors, a first forward connector (102a) configured to connect with a smart card and a second forward connector (102b) configured to connect with a POD card or module. FIG. 8 illustrates an adapter according to the present invention that provides two forward connectors, a first forward connector (102c) configured to connect with a PCMCIA card and a second forward connector (102b) configured to connect with a POD card or module. FIG. 9 illustrates an adapter according to the present invention that provides two forward connectors, a first forward connector (102d) configured to connect with a Memory Stick® and a second forward connector (102b) configured to connect with a POD card or module.

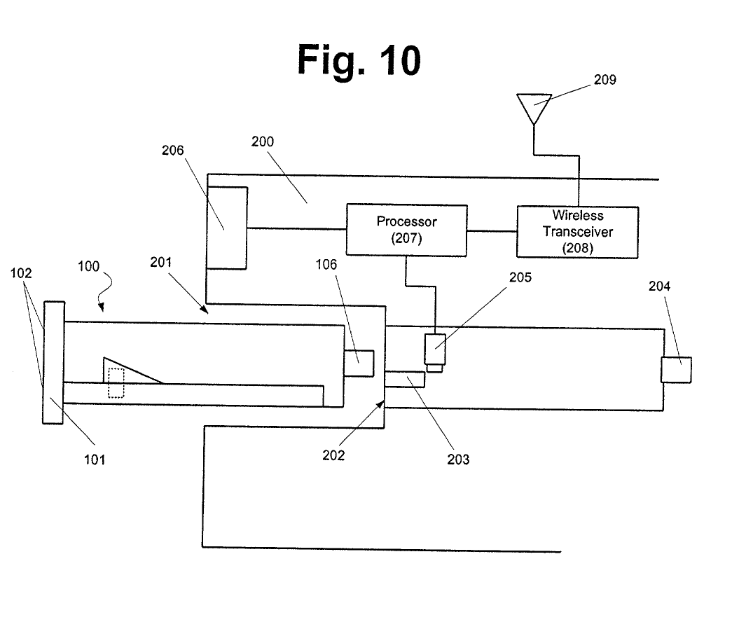

FIG. 10 illustrates the use of the adapter (100) of the present invention with an electronic device (200). The electronic device (200) may be any electronic device for which it is necessary or desirable to make an electrical connection with another electronic device. Specifically, the electronic device (200) may be, but is not limited to, a Set-Top Box (“STB”), interactive television set, digital video disk player, computer (desktop, laptop or palmtop), printer (or other computer peripheral) and other networked devices.

As shown in FIG. 10, the electronic device (200) preferably includes a port or receptacle (201) for receiving the adapter (100). This port (201) preferably allows the adapter (100) to be completely recessed within the electronic device (200) such that when a module or card is connected to the forward connector(s) (102) of the adapter (100), that module or card may also be partially or completely recessed within the housing of the electronic device (200). The port (201) for the adapter (100) also includes a connector (204) that connects the standard rear connector (106) of the adapter (100) with the electronics of the electronic device (200).

The port (201) may also include a stop (203) that extends from a sidewall of the port (201). Between this stop (203) and the bottom of the port (201) is a space (202) through which the guide rail (103) of the adapter may pass as the adapter (100) is guided into the port (201).

As the latch (104) passes under the stop (203), the latch (104) will be forced into a recess in guide rail (103) against the bias of the biasing device (105). After the latch (104) has passed the stop (203), the biasing device (105) will force the latch (104) into the extended position illustrated in FIG. 10. The latch (104) will then be caught behind the stop (203) and will prevent removal of the adapter (100) until released with the appropriate tool, as described above.

As will be appreciated by those skilled in the art, the arrangement illustrated could be equivalently implemented with a latch in the port (201) of the electronic device (200) that engages a stop on the adapter (100). Additionally, instead of requiring a special tool to release the adapter (100), a solenoid (205) may be positioned in the electronic device (200) to release the latch. (105). The electronic device (200) may have a user input device (206) such as a keypad that provides input to the device's processor (207). The processor (207) can control the solenoid (205). Thus, when a particular code or key sequence is input to the input device (206), the processor (207) will activate the solenoid (205) to release the latch (104).

The solenoid (205) could alternatively be used to replace the biasing device (105). The solenoid could then be extended to engage the stop (203) and lock the adapter in the device (200). The solenoid could also be retracted to release the latch (104).

Rather than controlling the solenoid (205) through a user input device (206), the code to activate the solenoid (205) and release the latch (104) may be transmitted to the electronic device (200). For example, if the electronic device is an STB, the code may be transmitted over the cable network to which the STB is connected. The electronic device (200) may also be a wireless device that includes an antenna (209) and wireless transceiver (208). This will allow the device (200) to receive wireless transmissions, including connecting the device (200) to a wireless home network. Preferably, the device (200) would employ the Data Over Cable Service Interface Specification (DOCSIS) in external electronic communications.

The preceding description has been presented only to illustrate and describe the invention. It is not intended to be exhaustive or to limit the invention to any precise form disclosed. Many modifications and variations are possible in light of the above teaching.

The preferred embodiment was chosen and described in order to best explain the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. An adapter for providing a connection for carrying electrical signals between an electronic device and a second or peripheral electronic device, the adapter comprising:
a rear connector for connection to said electronic device;
at least one forward connector for connection to said peripheral electronic device;
wherein said rear and said at least one forward connectors are electrically connected for carrying said electrical signals therebetween.

2. The adapter of claim 1, wherein said at least one forward connector comprises a plurality of forward connectors having different configurations for connecting to different peripheral electronic devices.

3. The adapter of claim 1, wherein said adapter is one of a set of adapters, each such adapter having an identical standard rear connector, but differently configured forward connectors.

4. The adapter of claim 1, wherein said electronic device is a set-top box and said peripheral electronic device is any of a Point-of-Deployment card or module, a PCMCIA card, a smart card or a Sony® Memory Stick®.

5. The adapter of claim 1, further comprising a guide rail for guiding said adapter into said electronic device.

6. The adapter of claim 1, further comprising a latch for holding said adapter in said electronic device until released with a tool specifically designed for releasing said latch.

7. The adapter of claim 1, further comprising:
a latch for holding said adapter in said electronic device; and
a solenoid for controlling said latch.

8. The adapter of claim 1, wherein said electronic device is a computer.

9. The adapter of claim 1, wherein said electronic device is an interactive television set.

10. The adapter of claim 1, wherein said electronic device is a networked device.

11. A method of connecting a particular primary electronic device to any of a number of second or peripheral electronic devices, without providing connectors on said primary electronic device for each possible peripheral electronic device, said method comprising:
selecting an adapter from a group of adapters, wherein each adapter in said group comprises a standard rear connector for connection to said electronic device, and wherein each adapter in said group also comprises at least one different forward connector for connection to a specific peripheral electronic device, said selecting being performed in accordance with a specific peripheral electronic device to which said primary electronic device is being connected; and
connecting a selected adapter between said primary and peripheral electronic devices for carrying electronic signals between said primary and peripheral electronic devices.

12. The method of claim 11, wherein said at least one forward connector comprises a plurality of forward connectors having different configurations for connecting to different peripheral electronic devices.

13. The method of claim 11, wherein said primary electronic device is a set-top box and said peripheral electronic device is any of a Point-of-Deployment card or module, a PCMCIA card, a smart card or a Sony® Memory Stick®.

14. The method of claim 11, wherein said connecting further comprises inserting said adapter in a port of said primary electronic device.

15. The method of claim 14, further comprising guiding said adapter into said port with a guide rail on said adapter.

16. The method of claim 14, further comprising:
latching said adapter in said port with a latch; and
releasing said latch with a special tool designed specifically to release said latch.

17. The method of claim 16, further comprising:
latching said adapter in said port with a latch; and
controlling said latch with a solenoid.

18. A primary electronic device that is connected with one or more adapters to any of a plurality of peripheral electronic devices, said primary electronic device comprising:
a port for receiving any of a group of adapters, wherein each adapter in said group comprises a standard rear connector for connection to said electronic device, and wherein each adapter in said group also comprises at least one different forward connector for connection to a specific peripheral electronic device;
said port further comprising a connector for receiving said standard rear connector of an adapter from said group of adapters.

19. The electronic device of claim 18, wherein said port further comprises a stop for engaging a latch on one of said adapters.

20. The electronic device of claim 18, further comprising means for latching one of said adapters in said port.

21. The electronic device of claim 20, wherein said means for latching further comprise means for controlling said latching means so as to prevent unauthorized release of said latching means.

22. The electronic device of claim 18, wherein said electronic device is a set-top box.

23. The electronic device of claim 18, wherein said electronic device is a computer.

24. The electronic device of claim 18, wherein said electronic device is an interactive television set.

25. The electronic device of claim 18, wherein said electronic device is a networked device.
